(19) United States
(12) Patent Application Publication
(10) Pub. No.: US 2026/0126097 A1
(43) Pub. Date: May 7, 2026

(54) ELECTRIC VEHICLE (EV) GEARBOX ASSEMBLY

(71) Applicant: BorgWarner Inc., Auburn Hills, MI (US)

(72) Inventors: Philip J. Francis, Lapeer, MI (US); Brian A. Nickoloff, Grand Blanc, MI (US); Gregory Beyerlein, Clarkston, MI (US); Matthew A. Biederwolf, Fishers, IN (US)

(21) Appl. No.: 18/939,584

(22) Filed: Nov. 7, 2024

(51) Int. Cl. F16H 3/00; F16H 3/093

(52) U.S. Cl. CPC F16H 3/0915; H02K 7/006; H02K 7/116; B60K 2001/001; F16H 2200/0021

(57) ABSTRACT

An electric vehicle (EV) gearbox assembly that can be equipped in an electric vehicle (EV) such as an automotive battery electric vehicle (BEV) is depicted and described. The EV gearbox assembly, per certain implementations, can include an electric motor, an input shaft, one or more speed gears, a first countershaft, and a second countershaft, among other possible components. The input shaft is rotationally driven by the electric motor, and the speed gear(s) is rotationally driven by the input shaft. Further, the first countershaft is rotationally driven by the speed gear(s). The second countershaft is situated rotationally downstream of the first countershaft, and has a concentric arrangement with respect to the input shaft.

### TECHNICAL FIELD

The present application relates to gearing and shaft layouts and arrangements in electric vehicle (EV) gearboxes and, more particularly, to gearbox assemblies in EVs such as automotive EV gearbox assemblies.

### BACKGROUND

Electric vehicle (EV) gearbox assemblies—such as automotive EV gearbox assemblies—serve to deliver the speed and torque requirements from electric motors and ultimately to vehicle wheels for driving purposes. Gear and shaft components, as well as electric motors and other components, are commonly packaged within gearbox housings. In the automotive industry, packaging and performance demands, as well as weight and cost demands, often collide and tend to create gearbox design and construction challenges that are not easily resolved.

### SUMMARY

In an implementation, an electric vehicle (EV) gearbox assembly is provided. The EV gearbox assembly can be an automotive EV gearbox assembly, as an example. The EV gearbox assembly may include an electric motor, an input shaft, one or more speed gears, a first countershaft, and a second countershaft. The input shaft is coupled with the electric motor and is rotationally driven by the electric motor. The speed gear(s) is rotationally driven by the input shaft. The first countershaft carries the speed gear(s) and is rotationally driven by the speed gear(s). The first countershaft has a radially offset arrangement and configuration with respect to the input shaft. The second countershaft is situated rotationally downstream of the first countershaft. The second countershaft has a radially offset arrangement and configuration with respect to the first countershaft and has a concentric arrangement and configuration with respect to the input shaft.

In another implementation, an electric vehicle (EV) gearbox assembly is provided. The EV gearbox assembly can be an automotive EV gearbox assembly, as an example. The EV gearbox assembly may include an electric motor, an input shaft, one or more speed gears, a first countershaft, and a second countershaft. The input shaft is rotationally driven by the electric motor. The input shaft has a proximal section and a distal section. The speed gear(s) is rotationally driven by the input shaft at the distal section of the input shaft. The first countershaft is rotationally driven by the speed gear(s). The second countershaft is situated rotationally downstream of the first countershaft. The second countershaft has a concentric arrangement and configuration with respect to the input shaft at the proximal section of the input shaft.

In yet another implementation, an electric vehicle (EV) gearbox assembly is provided. The EV gearbox assembly can be an automotive EV gearbox assembly, as an example. The EV gearbox assembly may include an electric motor, an input shaft, one or more speed gears, a disconnect assembly, a first countershaft, a countershaft gear, and a second countershaft. The input shaft is rotationally driven by the electric motor. The speed gear(s) is rotationally driven by the input shaft. The disconnect assembly is situated at or near the speed gear(s). The first countershaft is rotationally driven by the speed gear(s). The first countershaft has a radially offset arrangement and configuration with respect to the input shaft. The countershaft gear is rotationally driven by the first countershaft and has a concentric arrangement and configuration with respect to the input shaft. The second countershaft is rotationally driven by the countershaft gear. The second countershaft has a concentric arrangement and configuration with respect to the input shaft. Amid use of the EV gearbox assembly, rotational drive is transmitted and transferred from the electric motor, to the input shaft, to the speed gear(s), to the first countershaft, to the countershaft gear, to the second countershaft, and to a differential assembly situated rotationally downstream of the second countershaft.

### BRIEF DESCRIPTION OF THE DRAWINGS

FIG. 1 presents an embodiment of an electric vehicle (EV) gearbox assembly;

FIG. 2 is a sectional view of the EV gearbox assembly;

FIG. 3 is another sectional view of the EV gearbox assembly;

FIG. 4 is another sectional view, this one segmented, of the EV gearbox assembly;

FIG. 5 is a sectional view of another embodiment of the EV gearbox assembly; and

FIG. 6 is another sectional view of the EV gearbox assembly of FIG. 5.

### DETAILED DESCRIPTION

Embodiments of an electric vehicle (EV) gearbox assembly 10 are presented in the figures and detailed in this description. The EV gearbox assembly 10 can be equipped within an automotive EV gearbox such as for battery electric automobiles. In this regard, as used herein the term “electric vehicle” and grammatical variations thereof is intended to refer to vehicles that are propelled, either wholly or partially, by rotating electrical machines or motors such as battery electric vehicles (BEVs), plug-in electric vehicles, hybrid-electric vehicles, and battery powered vehicles. The EV gearbox assembly 10 exhibits a gearing and shaft layout and arrangement that is unlike past arrangements. Previously, output shafts were often configured in-line with accompanying electric motors, necessitating half-shafts that extend through the electric motors. Instead, here, in the embodiments of the figures, associated output shafts are radially offset from the associated electric motor, permitting optimization of the electric motor without having to accommodate the previous shaft constraints. Further, the EV gearbox assembly 10 exhibits a more efficient and effective gearing and shaft layout with a concentric shaft design and construction that resolves increasingly minimized packaging demands, while still satisfying high peak torque requirements and other performance needs of the larger electric vehicle this while also accommodating employment of a moderately-and suitably sized electric motor. Disconnect capabilities can also be incorporated into the EV gearbox assembly 10, per certain embodiments.

In automotive applications, such advancements are increasingly sought and often demanded of automotive companies. Still, a particular embodiment of the EV gearbox assembly 10 may exhibit only one or a combination of the advancements set forth herein, none of the advancements, or yet other advancements unmentioned. Furthermore, as used herein and unless otherwise specified, the terms radially, axially, and circumferentially, and their grammatical variations refer to directions with respect to the generally circular and cylindrical shape of the shafts and gears in the EV gearbox assembly 10, as illustrated in the figures. Yet further, as used herein, the terms upstream and downstream refer to directions with respect to the general and intended torque and rotational transfer movement and progression from input to output in the EV gearbox assembly 10.

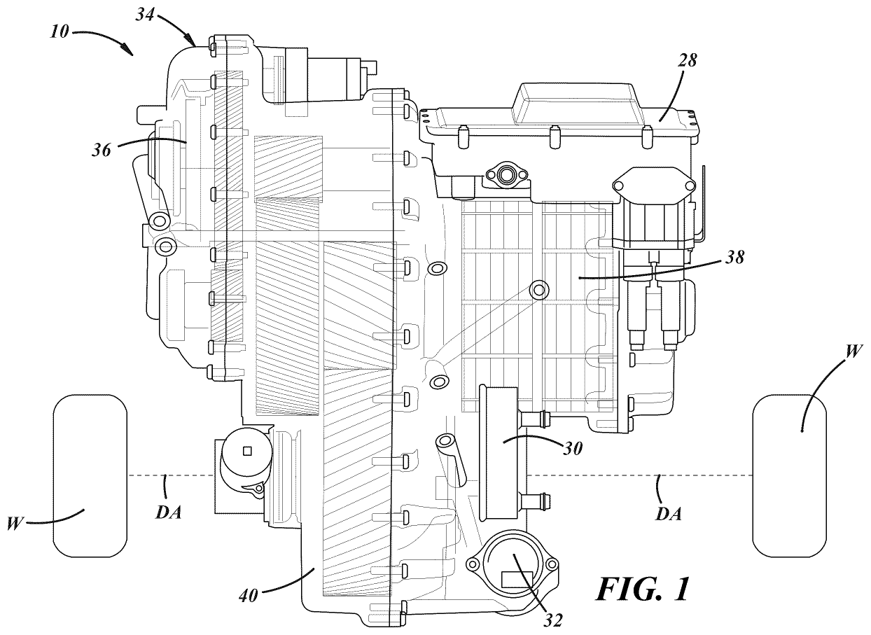

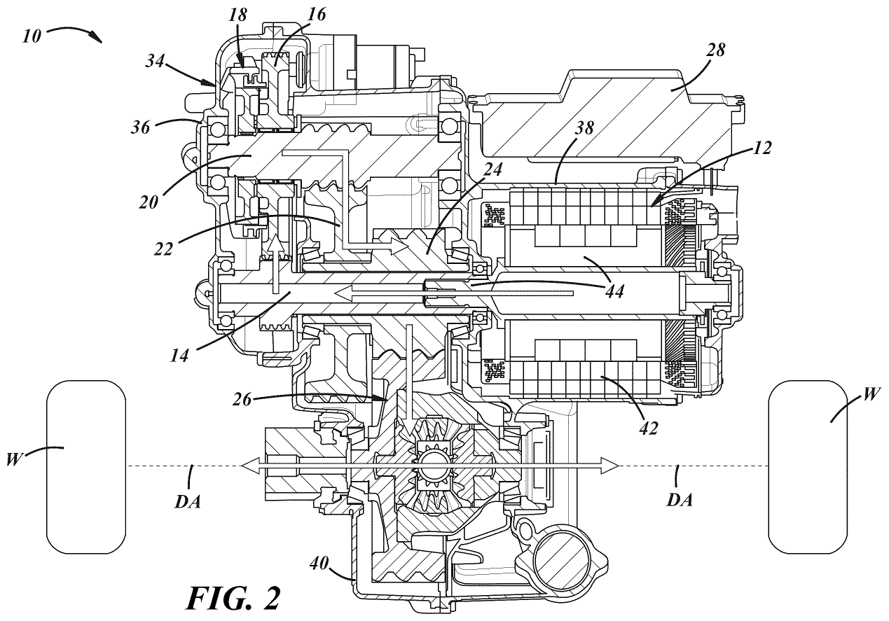

With reference to FIG. 1, the EV gearbox assembly 10 is installed within a larger accompanying EV powertrain to deliver rotational drive to vehicle wheels W. The EV gearbox assembly 10 serves to deliver the speed and torque requirements from an electric motor 12 and ultimately to the vehicle wheels W for driving purposes. The EV gearbox assembly 10 can have various designs, constructions, and components in various embodiments depending upon—among other potential factors—the EV powertrain in which the EV gearbox assembly 10 is installed and the intended torque performance parameters and requirements. In a first embodiment of FIGS. 2-4, the EV gearbox assembly 10 includes the electric motor 12, an input shaft 14, a speed gear 16, a disconnect assembly 18, a first countershaft 20, a countershaft gear 22, a second countershaft 24, and a differential assembly 26; still, more, less, and/or different components are possible in other embodiments.

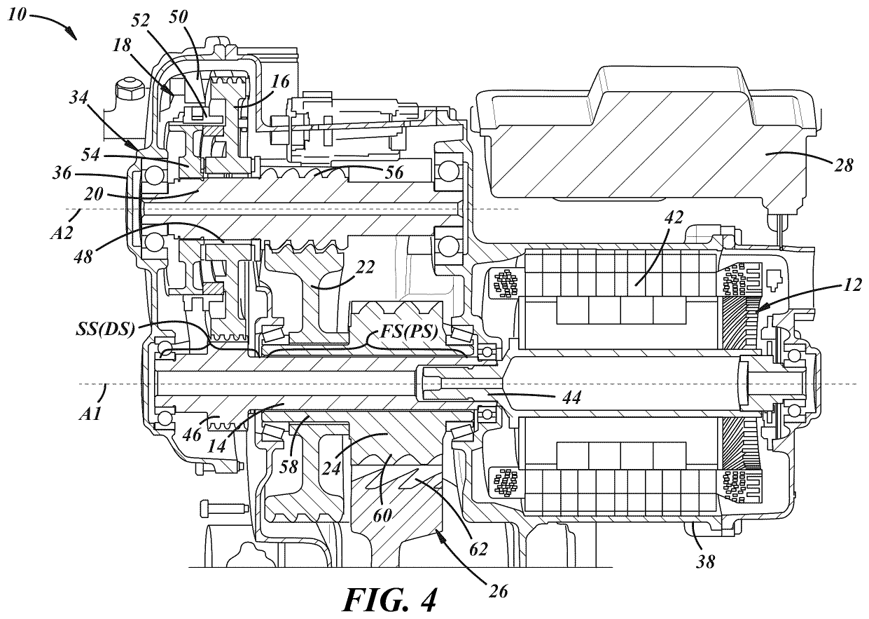

This first embodiment of the EV gearbox assembly 10 exhibits a single speed mode, and can furnish an overall torque ratio of 30:1 per an example (still, other torque ratios are possible in other examples). With particular reference to FIG. 4, with the exception of the differential assembly 26, the main components of the EV gearbox assembly 10 rotate about only two primary rotational axes amid operation and use: a first rotational axis Al and a second rotational axis A2. This has been determined to contribute to a compact packaging arrangement and configuration of the components of the EV gearbox assembly 10. The first and second rotational axes A1, A2 are radially offset and distanced with respect to each other. The electric motor 12, input shaft 14, countershaft gear 22, and second countershaft 24 rotate about the first rotational axis A1; and the speed gear 16 and first countershaft 20 rotate about the second rotational axis A2. Furthermore, in addition to the components set out above, skilled artisans may appreciate that the EV gearbox assembly 10 can include an inverter 28, a heat exchanger 30, and a pump 32. At least some of these components, like the shafts and gears, are packaged within a gearbox housing 34. Apart from its main portion, the gearbox housing 34 in this embodiment includes an end cover 36, a motor housing portion 38, and a differential portion 40.

The electric motor 12 serves to introduce the rotational drive in the EV gearbox assembly 10 and drives rotation of the input shaft 14. The electric motor 12 can have various designs, constructions, and components in various embodiments. With continued reference to FIGS. 2-4, in this embodiment, the electric motor 12 is supported and housed at the motor housing portion 38 of the gearbox housing 34. Relative to the other components of the EV gearbox assembly 10 and with respect to the orientation depicted in the figures, the electric motor 12 exhibits an axially offset arrangement and is distanced from the components in an axial direction. In general, the electric motor 12 has a stator 42 and a rotor and rotor shaft 44. The electric motor 12, and particularly its rotor shaft 44, exhibits a concentric arrangement with respect to the input shaft 14, with respect to the countershaft gear 22, and with respect to the second countershaft 24. The electric motor 12, input shaft 14, countershaft gear 22, and second countershaft 24 are coaxial relative to one another and share a central axis of rotation (namely, the first rotational axis A1). The electric motor 12 and its rotor shaft 44 rotate about the first rotational axis A1. The rotor shaft 44 has a direct coupling and connection with the input shaft 14, according to this embodiment. The rotor shaft 44 and input shaft 14 hence rotate in unison during use of the EV gearbox assembly 10. In an example, the electric motor 12 can be implemented as a permanent magnet synchronous drive motor having an operating voltage range of 300-800V; still, other examples of the electric motor 12 can exhibit other parameters.

The input shaft 14 is driven to rotate by the electric motor 12 and, in turn and downstream, drives rotation of the speed gear 16. The input shaft 14 can have various designs, constructions, and components in various embodiments. In this embodiment of the EV gearbox assembly 10, the input shaft 14 is situated immediately rotationally downstream of the electric motor 12 and its rotor shaft 44. No intervening components reside therebetween. The input shaft 14 is supported and housed at the main portion of the gearbox housing 34. The input shaft 14 exhibits a radially offset arrangement with respect to the speed gear 16 and first countershaft 20, and is distanced from the components in a radial direction. Further, the input shaft 14 exhibits a concentric arrangement with respect to the electric motor 12, with respect to the countershaft gear 22, and with respect to the second countershaft 24. The input shaft 14 rotates about the first rotational axis A1.

A total longitudinal and axial extent of the input shaft 14 spans from the electric motor 12 and to the end cover 36 of the gearbox housing 34. With particular reference to FIG. 4, the input shaft's longitudinal extent includes a first section FS and a second section SS. The first section FS per this embodiment constitutes a proximal section PS of the input shaft 14, and the second section SS constitutes a distal section DS of the input shaft 14. Coupling and connection between the input shaft 14 and electric motor 12 resides at the first section FS, and the concentric arrangement between the input shaft 14 and the countershaft gear 22 and second countershaft 24 is established at the first section FS. Axial overlap among the input shaft 14, countershaft gear 22, and second countershaft 24 occurs at the first section FS. Further, the input shaft 14 has an input shaft gear 46 that resides at the second section SS of the input shaft 14. In this embodiment, the input shaft gear 46 is monolithic with a main body of the input shaft 14 and, in this sense, is not a discrete component relative thereto. The input shaft gear 46 can be a helical gear or some other type of gear. Direct gear-to-gear engagement and teeth-to-teeth meshing takes place between the input shaft gear 46 and the speed gear 16 during use of the EV gearbox assembly 10.

The speed gear 16 is driven to rotate by the input shaft 14 and, in turn and downstream, drives rotation of the first countershaft 20 when a connection is established via the disconnect assembly 18. The speed gear 16 can have various designs, constructions, and components in various embodiments. With reference again to FIGS. 2-4, in this embodiment of the EV gearbox assembly 10, the speed gear 16 is situated immediately rotationally downstream of the input shaft 14. No intervening components reside therebetween. The speed gear 16 is supported and housed at the end cover 36 of the gearbox housing 34. The speed gear 16 exhibits an axially offset arrangement with respect to the countershaft gear 22 and is distanced from the component in an axial direction. Further, the speed gear 16 exhibits a concentric arrangement with respect to the first countershaft 20 and rotates about the second rotational axis A2. The speed gear 16 is supported and carried by the first countershaft 20. With particular reference to FIG. 4, in this embodiment a bearing 48 is disposed between the speed gear 16 and the first countershaft 20. The speed gear 16 rotates freely about the first countershaft 20 via the bearing 48. The bearing 48 can be a needle bearing or some other type of bearing. Further, the speed gear 16 can be a helical gear or some other type of gear. Direct gear-to-gear engagement and teeth-to-teeth meshing takes place between the speed gear 16 and the input shaft gear 46 during use of the EV gearbox assembly 10.

The disconnect assembly 18 serves to disconnect rotational drive of the speed gear 16 from the first countershaft 20. The disconnect assembly 18 can have various designs, constructions, and components in various embodiments. In this embodiment of the EV gearbox assembly 10, the disconnect assembly 18 is situated adjacent and at the speed gear 16. The disconnect assembly 18 is supported and housed at the end cover 36 of the gearbox housing 34. When in a connected state, rotational drive of the speed gear 16 is transmitted to the first countershaft 20 via the disconnect assembly 18; and when in a disconnected state, rotational drive from the speed gear 16 to the first countershaft 20 is absent. The disconnect assembly 18 is selectively actuated between the connected and disconnected states. With reference to FIG. 4, in this embodiment the disconnect assembly 18 includes a shift gear 50, a shift sleeve 52, and a shift hub 54; still, other types of disconnects can be provided with other embodiments as well as other disconnect components. Upon actuation, the shift gear 50 moves the shift sleeve 52 axially between a connected position and a disconnected position. The shift hub 54 is carried by, and fixed with, the first countershaft 20. When in the connected position, rotational drive is transmitted from the speed gear 16 and to the shift hub 54 via the shift sleeve 52, and then ultimately to the first countershaft 20. When in the disconnected position, rotational drive of the speed gear 16 is not transmitted to the shift hub 54. Still, in other embodiments, the disconnect assembly and capabilities could be employed at other places such as at the differential assembly.

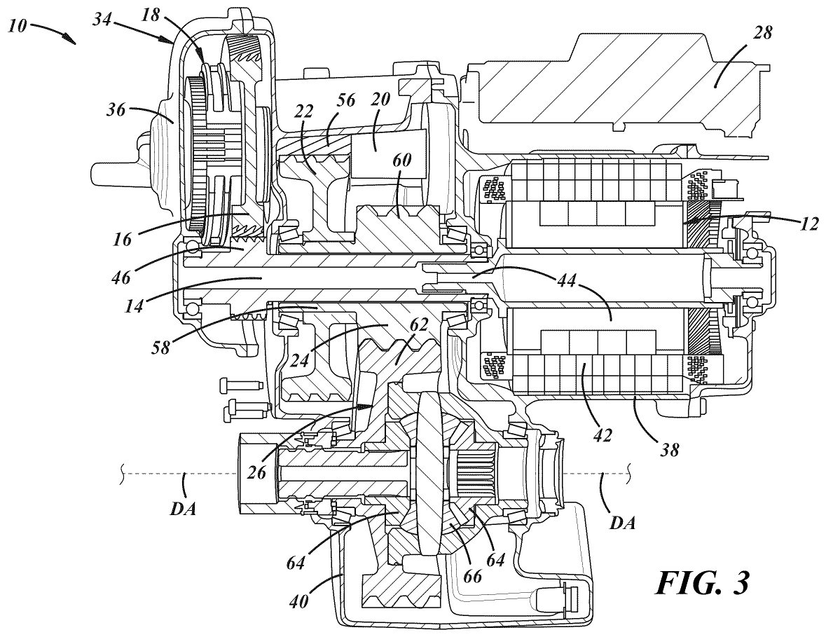

The first countershaft 20 is driven to rotate by the speed gear 16 and, in turn and downstream, drives rotation of the countershaft gear 22. The first countershaft 20 can have various designs, constructions, and components in various embodiments. With reference to FIGS. 3 and 4, in this embodiment of the EV gearbox assembly 10, the first countershaft 20 is situated immediately rotationally downstream of the speed gear 16. No intervening components reside therebetween. The first countershaft 20 is supported and housed at the main portion of the gearbox housing 34. The first countershaft 20 exhibits a concentric arrangement with respect to the speed gear 16 and rotates about the second rotational axis A2. The first countershaft 20 exhibits a radially offset arrangement with respect to the input shaft 14 and is distanced from the component in a radial direction. Further, the first countershaft 20 exhibits a radially offset arrangement with respect to the second countershaft 24 and is distanced from the component in a radial direction. A total longitudinal and axial extent of the first countershaft 20 can approximate that of the input shaft 14, according to this embodiment. Further, the first countershaft 20 has a first countershaft gear 56 that, in this embodiment, is monolithic with a main body of the first countershaft 20 and, in this sense, is not a discrete component relative thereto. The first countershaft gear 56 can be a helical gear or some other type of gear. Direct gear-to-gear engagement and teeth-to-teeth meshing takes place between the first countershaft gear 56 and the countershaft gear 22 during use of the EV gearbox assembly 10.

The countershaft gear 22 is driven to rotate by the first countershaft 20 and, in turn and downstream, drives rotation of the second countershaft 24. In the context of the first countershaft gear 56, the countershaft gear 22 can also be termed a second countershaft gear 22. The countershaft gear 22 can have various designs, constructions, and components in various embodiments. In this embodiment of the EV gearbox assembly 10, the countershaft gear 22 is situated immediately rotationally downstream of the first countershaft 20. No intervening components reside therebetween. The countershaft gear 22 is supported and housed at the main portion of the gearbox housing 34. The countershaft gear 22 exhibits an axially offset arrangement with respect to the speed gear 16 and is distanced from the component in an axial direction. The countershaft gear 22 also exhibits a radially offset arrangement with respect to the speed gear 16 and is distanced from the component in a radial direction. Further, the countershaft gear 22 exhibits a concentric arrangement with respect to the input shaft 14 and with respect to the second countershaft 24, and rotates about the first rotational axis A1. The countershaft gear 22 exhibits an axially overlapping arrangement with the input shaft 14 and with the second countershaft 24. The countershaft gear 22 is carried by, and fixed with, the second countershaft 24. Like other gears in this embodiment, the countershaft gear 22 can be a helical gear or some other type of gear. Direct gear-to-gear engagement and teeth-to-teeth meshing takes place between the countershaft gear 22 and the first countershaft gear 56 during use of the EV gearbox assembly 10.

The second countershaft 24 is driven to rotate by the countershaft gear 22 and, in turn and downstream, drives rotation of the differential assembly 26. The second countershaft 24 can have various designs, constructions, and components in various embodiments. In this embodiment of the EV gearbox assembly 10, the second countershaft 24 is situated immediately rotationally downstream of the countershaft gear 22. No intervening components reside therebetween. The second countershaft 24 is supported and housed at the main portion of the gearbox housing 34. The second countershaft 24 exhibits a radially offset arrangement with respect to the first countershaft 20 and is distanced from the component in a radial direction. Further, the second countershaft 24 exhibits a concentric arrangement with respect to the input shaft 14, and rotates about the first rotational axis A1. The second countershaft 24 exhibits an axially overlapping arrangement with the input shaft 14 and with the countershaft gear 22. For independent rotation between the second countershaft 24 and the input shaft 14, in this embodiment a bearing in the form of a needle bearing is sandwiched at an interfacial region between the second countershaft 24 and input shaft 14. With reference to FIG. 4, here, the second countershaft 24 has a sleeve portion 58 for receipt and carrying of the countershaft gear 22. Further, the second countershaft 24 has a third countershaft gear 60 that, in this embodiment, is monolithic with a main body of the second countershaft 24 and, in this sense, is not a discrete component relative thereto. The third countershaft gear 60 can be a helical gear or some other type of gear. Direct gear-to-gear engagement and teeth-to-teeth meshing takes place between the third countershaft gear 60 and a ring gear 62 of the differential assembly 26 during use of the EV gearbox assembly 10.

The differential assembly 26 is driven to rotate by the second countershaft 24 and, in turn and downstream, drives rotation of the wheels W. The differential assembly 26 can have various designs, constructions, and components in various embodiments. In this embodiment of the EV gearbox assembly 10, the differential assembly 26 is situated immediately rotationally downstream of the second countershaft 24. No intervening components reside therebetween. The differential assembly 26 is supported and housed at the differential portion 40 of the gearbox housing 34. The vehicle wheels W are coupled to the differential assembly 26 via drive axles DA (FIGS. 2 and 3) and are driven thereby; the drive axles DA permit the vehicle wheels W to rotate at different speeds such as amid cornering actions of the electric vehicle. The differential assembly 26 exhibits a radially offset arrangement with respect to the input shaft 14, with respect to the first countershaft 20, and with respect to the second countershaft 24, and is distanced from the components in a radial direction. With particular reference to FIG. 3, the differential assembly 26 is an open differential, but could be of another type in another embodiment. In general, the differential assembly 26 includes the ring gear 62, side gears 64 that can be connected to the drive axles DA, and a pinion carrier 66; still, the differential assembly 26 could have more, less, and/or different components in other embodiments.

In installation and during use of the EV gearbox assembly 10 according to this embodiment, rotational drive and torque transmission flow is initiated at the electric motor 12 and is transmitted downstream to and through the input shaft 14, to and through the speed gear 16, to and through the first countershaft 20, to and through the countershaft gear 22, to and through the second countershaft 24, and ultimately to and through the differential assembly 26 and to the vehicle wheels W.

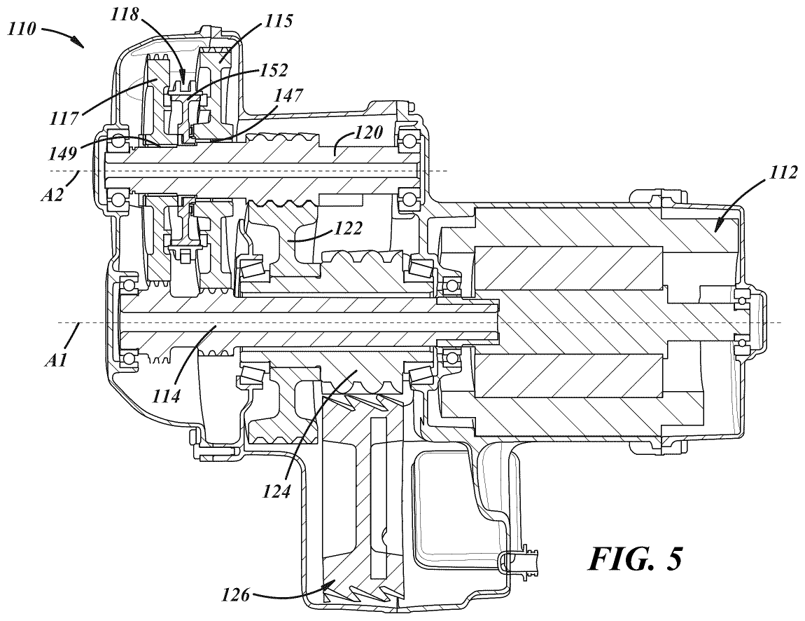

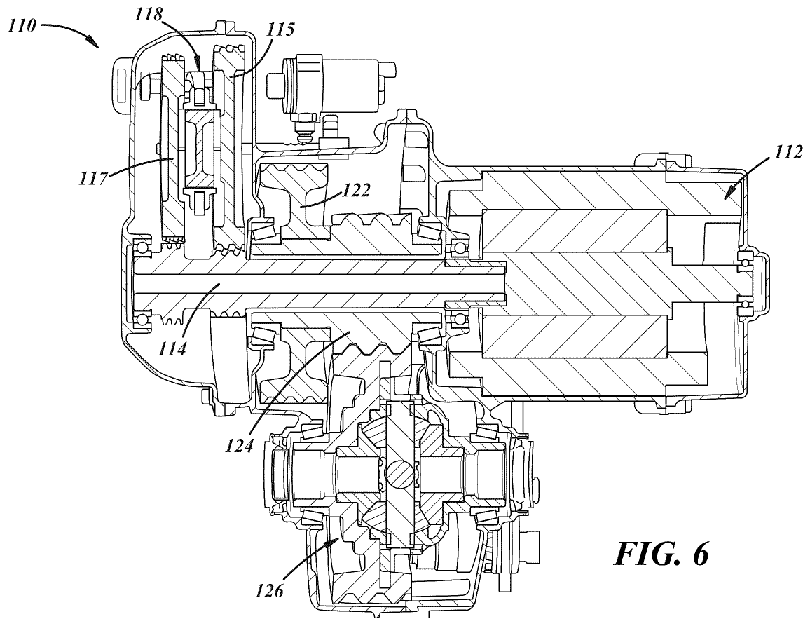

Turning now to FIGS. 5 and 6, a second embodiment of the EV gearbox assembly is presented. In the second embodiment, corresponding components and elements are numbered similarly but with numerals 1xx when referring to this second embodiment. For example, the EV gearbox assembly is referenced by numeral 10 in the first embodiment of FIGS. 1-4, and is correspondingly referenced by numeral 110 in the second embodiment of FIGS. 5 and 6. Moreover, many similarities exist between the first embodiment and the second embodiment, some of which may not be repeated here in the description of the second embodiment. At least certain appreciable differences between the embodiments are described.

In general, the EV gearbox assembly 110 exhibits a similar overall gearing and shaft layout as described for the first embodiment, as well as the same concentric and radially offset and axially offset arrangements as previously described. But the second embodiment of the EV gearbox assembly 110 has a two-speed design that provides two speed modes for the EV gearbox assembly 110. In the second embodiment of FIGS. 5 and 6, the EV gearbox assembly 110 includes an electric motor 112, an input shaft 114, a first speed gear 115, a second speed gear 117 a disconnect assembly 118, a first countershaft 120, a countershaft gear 122, a second countershaft 124, and a differential assembly 126; still, more, less, and/or different components are possible in other embodiments.

The EV gearbox assembly 110 can be shifted between the first and second speed gears 115, 117 for a first speed mode and a second speed mode. Upon actuation of the disconnect assembly 118, a shift sleeve 152 thereof moves axially among a first connected position for the first speed gear 115, a second connected position for the second speed gear 117, and a disconnected or neutral position for the disconnected state of the disconnect assembly 118.

The first and second speed gears 115, 117 are driven to rotate by the input shaft 114 and, in turn and downstream, drive rotation of the first countershaft 120 when a connection is established via the disconnect assembly 118. The first and second speed gears 115, 117 can have various designs, constructions, and components in various embodiments. In the second embodiment, the first and second speed gears 115, 117 are situated immediately rotationally downstream of the input shaft 114. No intervening components reside therebetween. The first and second speed gears 115, 117 exhibit an axially offset arrangement with respect to the countershaft gear 122 and are distanced from the component in an axial direction. Further, the first and second speed gears 115, 117 exhibit a concentric arrangement with respect to the first countershaft 120 and rotate about the second rotational axis A2. The first and second speed gears 115, 117 are supported and carried by the first countershaft 120. With particular reference to FIG. 5, in this embodiment first and second bearings 147, 149 are disposed between the first and second speed gears 115, 117 and the first countershaft 120. The first and second speed gears 115, 117 rotate freely about the first countershaft 120 via the first and second bearings 147, 149. The bearings 147, 149 can be needle bearings or some other type of bearings. Further, the first and second speed gears 115, 117 can be a helical gear or some other type of gear.

As used herein, the terms “general” and “generally” and “substantially” are intended to account for the inherent degree of variance and imprecision that is often attributed to, and often accompanies, any design and manufacturing process, including engineering tolerances-and without deviation from the relevant functionality and outcome-such that mathematical precision and exactitude is not implied and, in some instances, is not possible. In other instances, the terms “general” and “generally” and “substantially” are intended to represent the inherent degree of uncertainty that is often attributed to any quantitative comparison, value, and measurement calculation, or other similar representation.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An electric vehicle (EV) gearbox assembly, comprising:
an electric motor;
an input shaft coupled with the electric motor and rotationally driven by the electric motor;
at least one speed gear rotationally driven by the input shaft;
a first countershaft carrying the at least one speed gear and rotationally driven by the at least one speed gear, the first countershaft having a radially offset arrangement with respect to the input shaft wherein the at least one speed gear rotates freely about the first countershaft; and
a second countershaft situated rotationally downstream of the first countershaft, the second countershaft having a radially offset arrangement with respect to the first countershaft and having a concentric arrangement with respect to the input shaft.

2. The electric vehicle (EV) gearbox assembly as set forth in claim 1, wherein the at least one speed gear includes a first speed gear and a second speed gear, the first speed gear and the second speed gear being rotationally driven by the input shaft and being carried by the first countershaft, the first speed gear for a first speed mode setting of the EV gearbox assembly and the second speed gear for a second speed mode setting of the EV gearbox assembly.

3. The electric vehicle (EV) gearbox assembly as set forth in claim 1, further comprising a disconnect assembly situated adjacent the at least one speed gear and carried about the first countershaft, the disconnect assembly for disconnecting rotational drive of the at least one speed gear from the first countershaft.

4. The electric vehicle (EV) gearbox assembly as set forth in claim 1, further comprising a countershaft gear carried by the second countershaft and being rotationally driven by the first countershaft, the second countershaft being rotational driven by the countershaft gear.

5. The electric vehicle (EV) gearbox assembly as set forth in claim 4, wherein the countershaft gear and the at least one speed gear have a radially offset arrangement with respect to each other.

6. The electric vehicle (EV) gearbox assembly as set forth in claim 5, wherein the countershaft gear and the at least one speed gear have an axially offset arrangement with respect to each other.

7. The electric vehicle (EV) gearbox assembly as set forth in claim 4, wherein rotational drive is transmitted from the electric motor, to the input shaft, to the at least one speed gear, to the first countershaft, to the countershaft gear, to the second countershaft, and to a differential assembly situated rotationally downstream of the second countershaft.

8. The electric vehicle (EV) gearbox assembly as set forth in claim 1, wherein the input shaft has a first section and a second section, the concentric arrangement of the second countershaft with respect to the input shaft is established at the first section and engagement between the input shaft and the at least one speed gear for rotationally driving the at least one speed gear is established at the second section.

9. The electric vehicle (EV) gearbox assembly as set forth in claim 8, wherein the first section of the input shaft is a proximal section of the input shaft with respect to the electric motor, and the second section of the input shaft is a distal section of the input shaft with respect to the electric motor.

10. The electric vehicle (EV) gearbox assembly as set forth in claim 1, further comprising a differential assembly rotationally driven by the second countershaft, the differential assembly having a radially offset arrangement with respect to the first countershaft and with respect to the second countershaft and with respect to the input shaft.

11. The electric vehicle (EV) gearbox assembly as set forth in claim 10, wherein engagement between the second countershaft and a ring gear of the differential assembly drives rotation of the differential assembly.

12. An electric vehicle (EV) gearbox assembly, comprising:
an electric motor;
an input shaft rotationally driven by the electric motor, the input shaft having a proximal section and a distal section;
at least one speed gear rotationally driven by the input shaft at the distal section of the input shaft;
a first countershaft rotationally driven by the at least one speed gear wherein the at least one speed gear rotates freely about the first countershaft; and
a second countershaft situated rotationally downstream of the first countershaft and having a concentric arrangement with respect to the input shaft at the proximal section of the input shaft.

13. The electric vehicle (EV) gearbox assembly as set forth in claim 12, wherein the first countershaft has a radially offset arrangement with respect to the input shaft and has a radially offset arrangement with respect to the second countershaft.

14. The electric vehicle (EV) gearbox assembly as set forth in claim 12, wherein the at least one speed gear includes a first speed gear and a second speed gear, the first speed gear and the second speed gear being rotationally driven by the input shaft, the first speed gear for a first speed mode setting of the EV gearbox assembly and the second speed gear for a second speed mode setting of the EV gearbox assembly.

15. The electric vehicle (EV) gearbox assembly as set forth in claim 12, further comprising a disconnect assembly situated adjacent the at least one speed gear, the disconnect assembly for disconnecting rotational drive of the at least one speed gear from the first countershaft.

16. The electric vehicle (EV) gearbox assembly as set forth in claim 12, further comprising a countershaft gear carried by the second countershaft and being rotationally driven by the first countershaft, the second countershaft being rotational driven by the countershaft gear, the countershaft gear having a concentric arrangement with respect to the input shaft at the proximal section of the input shaft.

17. The electric vehicle (EV) gearbox assembly as set forth in claim 16, wherein rotational drive is transmitted from the electric motor, to the input shaft, to the at least one speed gear, to the first countershaft, to the countershaft gear, to the second countershaft, and to a differential assembly situated rotationally downstream of the second countershaft.

18. The electric vehicle (EV) gearbox assembly as set forth in claim 12, further comprising a differential assembly rotationally driven by the second countershaft, the differential assembly having a radially offset arrangement with respect to the first countershaft and with respect to the second countershaft and with respect to the input shaft.

19. An electric vehicle (EV) gearbox assembly, comprising:
an electric motor;
an input shaft rotationally driven by the electric motor;
at least one speed gear rotationally driven by the input shaft;
a disconnect assembly situated adjacent the at least one speed gear;
a first countershaft rotationally driven by the at least one speed gear, the first countershaft having a radially offset arrangement with respect to the input shaft wherein the at least one speed gear rotates freely about the first countershaft;
a countershaft gear rotationally driven by the first countershaft and having a concentric arrangement with respect to the input shaft; and
a second countershaft rotationally driven by the countershaft gear and having a concentric arrangement with respect to the input shaft;
wherein, during use of the EV gearbox assembly, rotational drive is transmitted from the electric motor, to the input shaft, to the at least one speed gear, to the first countershaft, to the countershaft gear, to the second countershaft, and to a differential assembly situated rotationally downstream of the second countershaft.

20. The electric vehicle (EV) gearbox assembly as set forth in claim 19, wherein, during use of the EV gearbox assembly, the electric motor, input shaft, countershaft gear, and second countershaft all rotate about a first rotational axis, and the at least one speed gear and first countershaft rotate about a second rotational axis.
